(19) United States
(12) Patent Application Publication
(10) Pub. No.: US 2008/0131742 A1
(43) Pub. Date: Jun. 5, 2008

(54) METHOD AND APPARATUS TO SENSE AND CONTROL A MALFUNCTION IN BALANCE OF PLANT FOR FUEL CELL

(75) Inventors: Jin-hong AN, Yongin-si (KR); Ho-jin Kweon, Yongin-si (KR); Ri-a Ju, Yongin-si (KR)

Correspondence Address: STEIN, MCEWEN & BUI, LLP, 1400 EYE STREET, NW, SUITE 300, WASHINGTON, DC, 20005, US

(73) Assignee: SAMSUNG SDI CO., LTD., Suwon-si (KR)

(21) Appl. No.: 11/930,520

(22) Filed: Oct. 31, 2007

(30) Foreign Application Priority Data
Nov. 3, 2006 (KR) 2006-108458

(51) Int. Cl. H01M 8/04

(52) U.S. Cl. 429/13; 429/22; 429/23

(57) ABSTRACT

An apparatus to sense and control a malfunction in balance of plant for a fuel cell includes a microprocessor having an ALU to perform calculations, a register to temporally store data and instructions, and a controller to control the operation of the fuel cell system. The microprocessor includes a first input stage input with a first detecting signal to operate the fuel cell system, an output stage to apply a control signal generated by the controller to balance of plant, and a second input stage to receive a second detecting signal to detect a malfunction in balance of plant.

### CROSS-REFERENCE TO RELATED APPLICATION

This application claims the benefit of Korean Patent Application No. 2006-108458, filed on Nov. 3, 2006, in the Korean Intellectual Property Office, the entire content of which is incorporated herein by reference.

### BACKGROUND OF THE INVENTION

1. Field of the Invention

Aspects of the present invention relate to an apparatus and a method for stably controlling a fuel cell system, and more specifically, to an apparatus and a method for sensing and controlling malfunctions in balance of plant for a fuel cell, which can sense a malfunction in the balance of plant, and control the balance of plant in optimal state or output a system alarm, based on the sensed information.

2. Description of the Related Art

A fuel cell is a power generation system that directly converts fuel energy into electric energy, and the fuel cell is advantageous because of low pollution and high efficiency. In particular, the fuel cell uses energy sources such as petroleum energy, natural gas, and methanol, etc., which are easy in a store and transport, in order to generate electric energy, such that it has been spotlighted as next generation energy source. Such a fuel cell is classified into a phosphoric acid fuel cell, a molten carbonate fuel cell, a solid oxide fuel cell, a polymer electrolyte fuel cell, an alkaline fuel cell, or etc., according to the type of electrolyte used. These fuel cells are operated based on basically the same principle, but differ from one another in the kind of fuel, the driving temperature, the catalyst, and the electrolyte, etc.

The polymer electrolyte membrane fuel cell (PEMFC) uses a polymer membrane as an electrolyte and has advantages of high output characteristics with high current density, a simple structure, rapid starting and answering characteristics, and excellent durability over other fuel cells. The PEMFC can use as fuel methanol or natural gas in addition to pure hydrogen so that it can widely be applied to various fields such as a power source for an automobile, a distributed on-site generator, an emergency power source for military, and a power source for a spaceship, etc.

The direct methanol fuel cell (DMFC) uses a polymer membrane as an electrolyte and has a structure capable of directly supplying liquid methanol aqueous solution as fuel to an anode. The DMFC is more suited to a portable or a small-sized fuel cell structure as compared with the polymer electrolyte membrane fuel cell as described above as it does not have a fuel reformer and is operated at temperature less than 100C.

FIG. 1A is a schematic view showing a general fuel cell system. FIG. 1B is a view showing a general fuel cell stack using a polymer membrane as an electrolyte.

As shown in FIG. 1A, the general fuel cell system includes a fuel cell stack 10 generating electric energy by electrochemically reacting fuel supplied to its anode and oxidizer supplied to its cathode and supplying the generated electric energy to an external load 18; a fuel supplier 12 supplying hydrogen-containing fuel to the fuel cell stack 10; an oxidizer supplier 14 supplying oxidizer such air, etc., to the fuel cell stack 10; and in order to control a system, a controller for detecting system state variables such as voltage V, current 1, and temperature T, etc., and controlling the fuel supplier 12 and the oxidizer supplier 14 according to the detected information.

The fuel cell stack 10, as shown in FIG. 1B, includes a polymer electrolyte membrane 1 and an anode electrode 2 and a cathode electrode 3 bonded to both sides of the electrolyte membrane 1. The electrolyte membrane 1, the anode electrode 2, and the cathode electrode 3 form a unit cell referred to as a membrane-electrode assembly (MEA). The anode electrode 2 and the cathode electrode 3 include metal catalyst layers 2b and 3a and diffusion layers 2a and 3b in order to improve performance of electrochemical reaction, ion conductivity, electron conductivity, fuel or oxidizer transferability, by-product transferability, and interface stability, etc. Also, the fuel cell stack 10 includes a bipolar plate 5 installed between unit cells, a monopolar plate 5a installed between a unit cell and an end plate 6a, and another monopolar plate 5b between another unit cell and another end plate 6b. Each of the plates 5, 5a, and 5b has electrical conductivity and is provided with a flow field a1 for supplying fuel and/or a flow field a2 for supplying oxidizer in one side or both sides thereof. The laminate of the plurality of unit cells and the plates 5, 5a, and 5b is pressed and fixed by a pair of end plates 6a and 6b and connecting members 7.

The fuel cell system is operated as follows. First, if a hydrogen-containing fuel, such as a reforming gas obtained by reforming fossil fuel, is supplied from the fuel supplier 12 to the anode electrode of the fuel cell stack 10 and an oxidizer, such as air, is supplied to the cathode electrode 3, the oxidation reaction of fuel occurs in the metal catalyst layer 2a of the anode side to generate hydrogen protons and the generated hydrogen protons move to the cathode electrode 3 via the polymer electrolyte membrane 1. The reduction reaction of oxygen in the oxidizer occurs in the metal catalyst layer 3a of the cathode side to generate water. At this time, electrons generated in the metal catalyst layer 2b of the anode side moves to the metal catalyst layer 3a of the cathode side via an external circuit (not shown) to transform variations of free energy obtained from the electrochemical reaction to electric energy.

The conventional fuel cell system includes a balance of plant (BOP) for a fuel cell such as a liquid pump to supply fuel, an air pump to supply oxidizer to the fuel cell stack, a valve to control flow of fluid, and a pan to control a system temperature. The balance of plant operates in various driving manners such as pulse width modulation (PWM), pulse edge modulation (PEM), and on/off, or the like according to their functions or demands.

However, the BOP including a rotating apparatus, such as a motor, among the balance of plant of the fuel cell often malfunctions due to friction or abrasion by fuel, impurities accumulated in the fuel pump, and temperature variation of the system, etc. If the malfunction frequency of the fuel cell increases, a desired amount of fuel cannot be supplied due to the malfunction in the fuel pump in the fuel cell system. Failure of the fuel pump decreases an operating efficiency by changing the concentration of fuel to an undesired concentration rather than an optimal concentration. Such changes in concentration decrease the output characteristics of the fuel cell system.

As such, in the conventional fuel cell system, the malfunction in the balance of plant of the fuel cell can adversely affect stability and reliability of the system. For example, it is difficult to maintain a concentration of a fuel supplied to the fuel cell stack at a desired concentration when there is a malfunction in the fuel pump and therefore, it is difficult to continuously and stably operate the fuel cell system.

### SUMMARY OF THE INVENTION

Aspects of the present invention provide an apparatus and a method for sensing and controlling a malfunction in a balance of plant for a fuel cell capable of securing stability of a system and preventing an adverse effect on a continuous operation of a system by sensing a malfunction in the balance of plant, compensating for the error caused by the malfunction, and initializing the balance of plant or generating an alarm.

According to aspects of the present invention, there is an apparatus to sense and control a malfunction in balance of plant for a fuel cell, the apparatus being coupled with a fuel cell system including a fuel cell stack to generate electric energy by electrochemically reacting fuel with oxidizer and the balance of plant to supply the fuel and the oxidizer, the apparatus including: a microprocessor having an ALU to perform calculations; a register to temporally store data and instructions; and a controller to control the operation of the fuel cell system; a first input stage input with a first detecting signal to operate the fuel cell system; an output stage to apply the control signal generated by the controller to the balance of plant; and a second input stage input with a second detecting signal to detect the malfunction in the balance of plant.

According to another aspect of the present invention, there is a method for sensing and controlling a malfunction in a balance of plant for a fuel cell with an apparatus to sense and control that is coupled with a fuel cell system including a fuel cell stack generating electric energy by electrochemically reacting fuel with oxidizer and the balance of plant having a fuel supplier to supply the fuel, the method comprising: receiving signals transferred from a sensor, which is coupled with the fuel supplier and detects, in time intervals, at least one selected from a group consisting of a driving voltage, a driving current, and a driving waveform; sensing whether the received first signal is beyond a reference range; initializing the fuel supplier; sensing whether the received second signal returns to the reference range; and compensating for errors caused by the malfunction in the fuel supplier.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a schematic view showing a general fuel cell system;

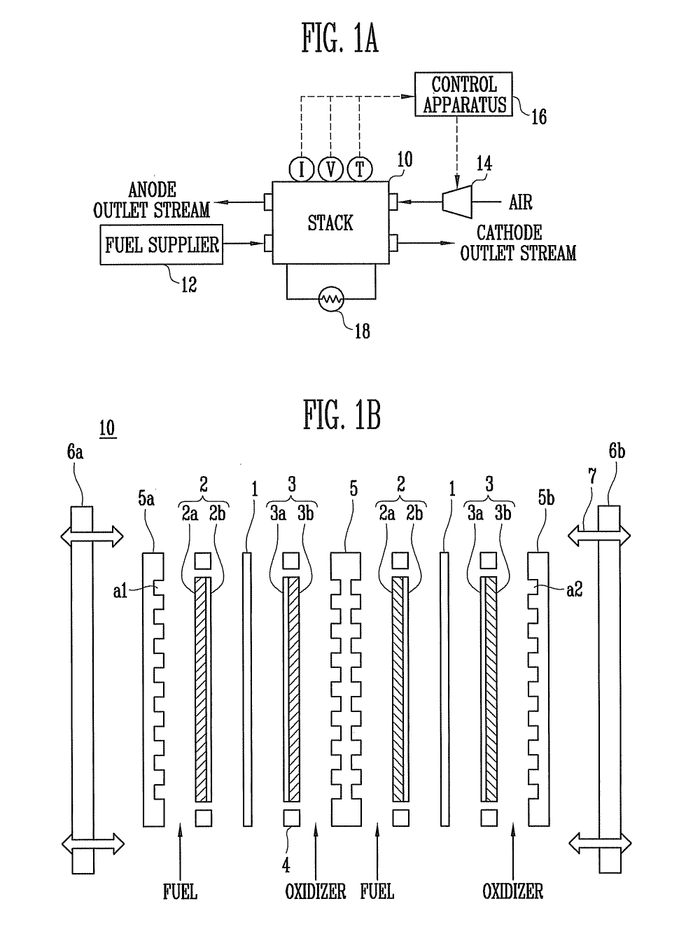

FIG. 1B is a view for explaining a general fuel cell using polymer membrane as electrolyte;

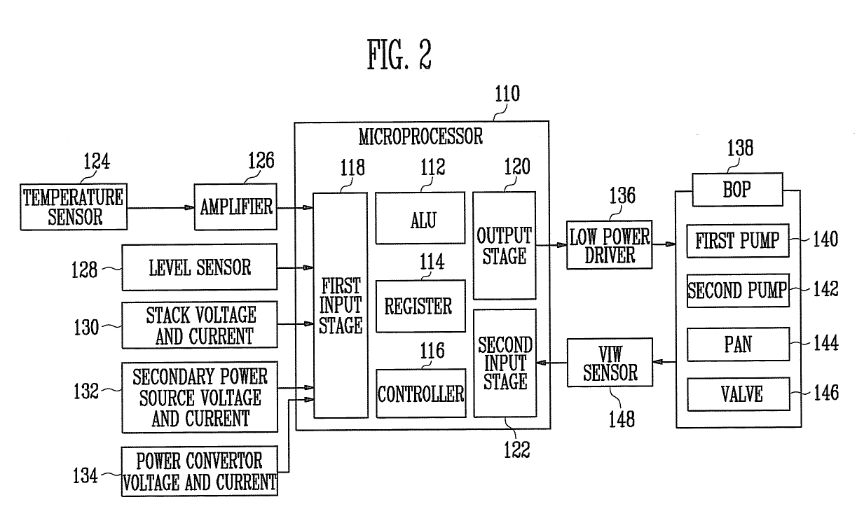

FIG. 2 is a block view showing an apparatus for detecting controlling balance of plant according to aspects of the present invention;

FIG. 3A and FIG. 3B are flow charts for explaining an operating principle of an apparatus to sense and control a malfunction in BOP in FIG. 2; and

FIG. 4 is a view for explaining results to which the method sensing and controlling a malfunction in BOP according to aspects of the present invention is applied.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

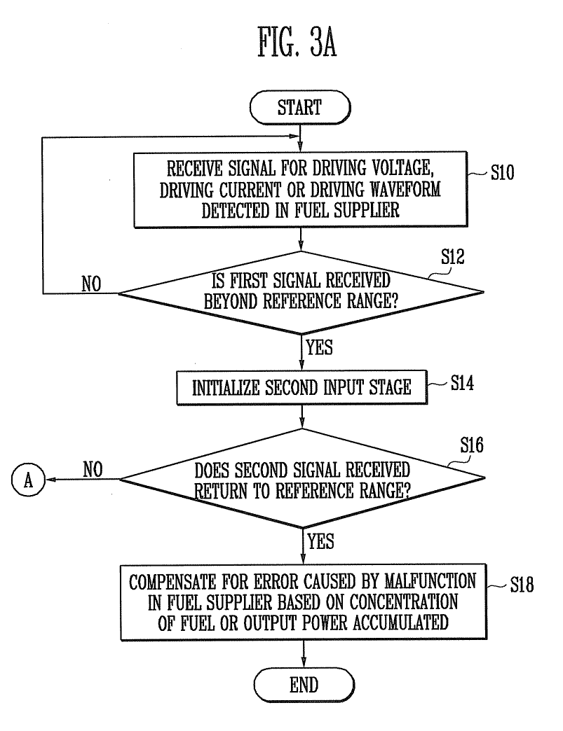

FIG. 2 is a block view showing an apparatus to sense and control a malfunction in BOP according to aspects of the present invention. Referring to FIG. 2, the apparatus to sense and control the malfunction in BOP is a control apparatus mounted in a fuel cell system. The control apparatus may be implemented as a microprocessor 110. Further, the control apparatus may be implemented as software and/or firmware used by a computer and/or processor.

The microprocessor 110 includes an arithmetic logic unit (ALU) 112 to perform calculations, a register 114 to temporally store data and instructions, and a controller to control an operation of a system. Further, the microprocessor 110 includes a first input stage 118 through which the microprocessor 110 receives at least a first detecting signal to operate the fuel cell system; an output stage 120 to output a control signal generated by the controller 116 to the BOP 138 of the fuel cell; and a second input stage 122 through which the microprocessor 110 receives at least a second detecting signal to detect malfunction of the BOP 138.

The first detecting signal input to the first input stage 118 of the microprocessor 110 is a signal having information on system state variables. For example, the first detecting signal includes an output signal of a first sensor 124 which measures a temperature of the fuel cell stack, the BOP 138, or the like; an output signal of a second level sensor 128 which measures a level of fluid stored in a fuel storing tank, a fuel circulating tank, and a water tank, etc.; an output signal of a third sensor 130 to measure voltage or current of the fuel cell stack; an output signal of a fourth sensor 132 to measure voltage or current of a subsidiary power source such as a secondary battery, a capacitor, and a super capacitor, etc.; and an output signal of a fifth sensor 134 to measure a primary or a secondary voltage or current of a power converter such as a current and/or voltage converter. An output signal from a specific sensor can be amplified through an amplifier 126 and then input to the first input stage 118. Further, the first input stage 118 is not limited to receiving the output signals from only the first through fifth sensors; for example, the first input stage 118 may accept output signals from other elements of the fuel cell system.

The control signal output from the output stage 120 of the microprocessor 110 is a signal for controlling the operation of the BOP 138 and is transferred to a BOP driver 136 controlling the operation of the BOP 138. The BOP driver 136 is implemented as a low power driver so as to improve efficiency of the system. The low power driver is an apparatus to control the operation of the BOP 138 and the control signal as described above is applied to the low power driver.

The BOP 138 may include a first pump 140, a second pump 142, a pan 144, and a valve 146. The BOP 138 may be configured to include the first pump 140, the second pump 142, the pan 144, and the valve 146 or any one or combination thereof. The first pump 140 may be a fuel pump to supply fuel stored in the fuel tank to the fuel circulating tank or the fuel cell stack. The second pump 142 may be an air pump to supply an oxidizer such as air to the fuel cell stack. The pan 144 is an apparatus to control heat exchange and/or a temperature of water and fuel in the system. The valve is an apparatus to control an amount of water, fuel, and circulation fluid moving throughout the fuel cell system.

The second detecting signal input to the second stage of the microprocessor 110 is a signal to detect a malfunction in the BOP 138 and includes an output signal of a VIW sensor 148 that detects at least one selected from a group consisting of a driving voltage, a driving current, and a driving waveform of the specific BOP, for example, the first pump 140.

The VIW sensor 148 includes at least one of a voltage sensor to measure the driving voltage of the specific BOP, a current sensor to measure the driving current of the specific BOP, and a sensor to measure a period of a waveform and a duty ration applied to the specific BOP by using a timer to measure the driving waveform of the specific BOP. The duty ratio may indicate on-off ratio of pulse width modulation (PWM).

The microprocessor 110 receives the second detecting signal transferred from the VIW sensor 148, which measures, at predetermined time intervals, at least one selected from a group consisting of a driving voltage, a driving current, and a driving waveform of the specific BOP such as fuel supplier. The microprocessor 110 also determines whether the second detecting signal is beyond a reference range or a marginal reference range. Herein, the reference range is a normal operating range of the BOP outside of which operation is abnormal and the marginal reference range indicates an operating range that is abnormal. Examples of the normal operating range and the abnormal operating range of the driving voltage and the driving current of the several BOPs are as follows.

TABLE 1

| | |
|---|---|
| normal operation | abnormal operation |

| BOPs | voltage[V] | current[A] | voltage[V] | current[A] |
|---|---|---|---|---|
| fuel pump | 5.5~6.5 | 0.2~0.3 | over ±1.0 | over ±0.05 |
| air pump | 9.5~10.5 | 0.3~0.4 | over ±1.0 | over ±0.05 |
| pan | 4.5~5.5 | 0.1~0.2 | over ±0.5 | over ±0.05 |
| valve | 4.5~5.5 | 0.1~0.2 | over ±0.5 | over ±0.05 |

As an example, a reference range for the pan (i.e., the pan 144) from Table 1 is 4.5 to 5.5V such that if the pan 144 is operating within a range of 4.5 to 5.5V, the operation of the pan 144 is normal. However, if the pan 144 is operating within ±0.5V from the normal operating range, i.e., operating in a marginal reference range, the operation of the pan 144 is abnormal. As such, the marginal reference range for the pan is operating within 4.0 to 4.5V and 5.5 to 6.0V. If the pan operates beyond the marginal reference range, then the BOP and the fuel cell system may be had a bad effect on their operations.

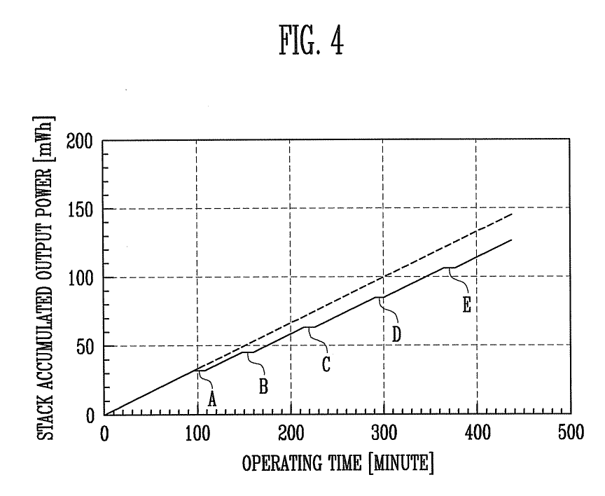

The microprocessor 110 is coupled with a memory system (not shown) such as a ROM, a RAM, and a hard disk, etc., and can control to compensate for errors caused by a malfunction in the BOP based on information about an accumulated output power (see FIG. 4) of the fuel cell stack stored in the memory system.

The microprocessor 110 can be implemented as at least one of processors having various architectures such as Alpha from Digital Co., MIPS from MIPS Technology, NEC, IDT, and Siemens, etc., x86 from companies including Intel and Cyrix, AMD and Nexgen, Power PC from IMB and Motorola, and ARM from ARM company. Furthermore, the first input stage 118 and the second input stage 122 can be implemented as an analog-to-digital converter, and the output stage 120 can be implemented as a digital-to-analog converter and/or an output buffer.

The microprocessor 110 according to aspects of the present invention is coupled with a fuel cell system, which includes the fuel cell stack that generates electric energy by electrochemically reacting fuel with an oxidizer and the BOP 138 including at least the fuel supplier to supply the fuel to the fuel cell stack. Furthermore, the microprocessor 110 determines a malfunction in the BOP 138 according to signals input from the VIW sensor coupled with the BOP 138 and/or a signal input form a level sensor or the information about the accumulated output power of the fuel cell stack; and compensates for errors caused by the malfunction or initializes the malfunctioning in the specific BOP or the microprocessor itself, thereby stabilizing the fuel cell system.

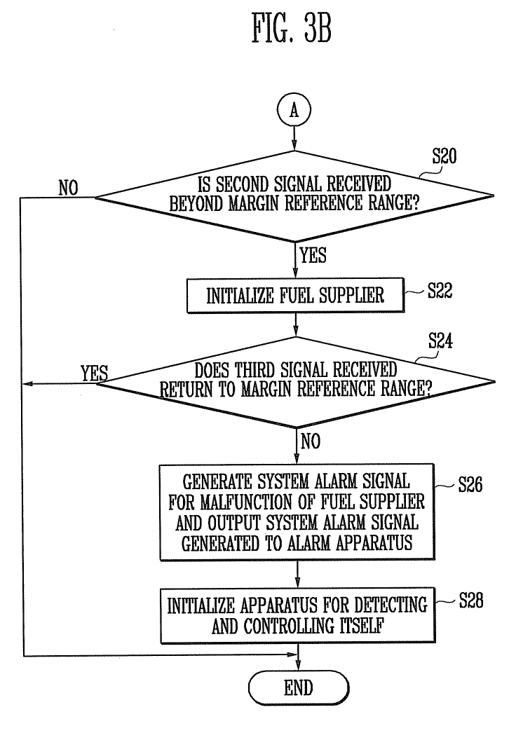

FIG. 3A and FIG. 3B are flow charts illustrating an operating principle of an apparatus to sense and control a malfunction in the specific BOP according to aspects of the present invention.

The process for sensing and controlling a malfunction in the fuel supplier including a fuel pump as the specific BOP will be described in more detail. In the following description, the apparatus to sense and control a malfunction in the BOP corresponds to the foregoing microprocessor. And, the first signal, the second signal, and the third signal correspond to the second detecting signal transferred from the VIW sensor at predetermined time intervals.

As shown in FIG. 3A, in the apparatus to sense and control a malfunction in the BOP, a first signal for at least one selected from a group consisting of a driving voltage, a driving current, and a driving waveform detected in the fuel supplier through the VIW sensor is repeatedly received at constant time intervals (S10).

Next, the apparatus to sense and control a malfunction in the BOP determines whether the first signal received is beyond a reference range (S12). As a result of the determination in the operation S12, if the first signal is beyond the reference range, the second input stage input with the first signal is initialized (S14). Initialization of the second input stage confirms whether there is error in the first signal itself, considering the case where the output signal from the VIW sensor is distorted by external influences such as noise. However, as a result of the determination in the operation S12, if the first signal is within the reference range, it returns to the operation S10.

Next, the microprocessor receives the second signal after initializing the second input stage in operation S14 and determines whether the second signal received returns within the reference range (S16). The second signal is a signal, output from the VIW sensor after the first signal and input to the second input stage. As a result of the determination in the S16, if the second signal returns within the reference range, the apparatus to sense and control a malfunction in the BOP generates a control signal for a compensation control and applies the generated control signal to the fuel supplier to compensate for the errors caused by the malfunction in the fuel supplier (S18).

Compensation for the errors caused by the malfunction in the fuel supplier can be implemented in a manner that further supplies an amount of fuel corresponding to the malfunction intervals (see A, B, C, D, and E of FIG. 4) based on an accumulated output power of the fuel cell stack, i.e., the amount of fuel to compensate for a shortage of fuel to the fuel cell stack when the generation frequency of the malfunction is above a predetermined frequency.

In addition, compensation for the errors caused by the malfunction in the fuel supplier can be implemented in a manner that detects the concentration of fuel when the generation frequency of the malfunction is above a predetermined frequency and compares the detected concentration with a reference concentration, and then further supplies the amount of fuel corresponding to the concentration difference between the compared values. Herein, the predefined concentration of fuel may be the concentration of fuel corresponding to an output voltage, an output current, and a temperature of the fuel cell stack. However, a fuel concentration sensor may be applied.

As a result of the determination in the S16, if the second signal does not return within the reference range, a system alarm can be output and the controlling process terminated.

Further, as a result of the determination in the S16, if the second signal does not return within the reference range, the malfunctioning fuel supplier can be initialized or the apparatus to sense and control a malfunction in the BOP can be initialized. Such operations will be described in more detail below.

As shown in FIG. 3B, as a result of the determination in the operation S16, if the second signal does not return within the reference range, the apparatus to sense and control the malfunction in the BOP determines whether the second signal is beyond the marginal reference range (S20). The operation S20 determines whether the malfunction in the fuel supplier can adversely affect the fuel cell system, i.e., if the second signal is beyond the marginal reference range, the malfunctioning apparatus of the BOP may damage the BOP or the fuel cell system.

As a result of the determination in the operation S20, if the second signal is beyond the marginal reference range, the fuel supplier is initialized (S22). The initialization of the fuel supplier may include turning-off the operation of the fuel supplier. The operation S22 is to adjust to unexpected errors of the fuel supplier due to environment, such as temperature, etc. Meanwhile, as a result of the determination in the operation S20, if the second signal is within the marginal reference range, the process for sensing and controlling a malfunction in the BOP is terminated and restarted.

If the second signal is beyond the marginal reference range as determined in the operation S20, the apparatus for sensing and controlling a malfunction in the BOP initializes the fuel supplier (S22), receives a third signal, and determines whether the third signal received returns within the marginal reference range (S24). The third signal is a signal output from the VIW sensor after the second signal and input to the second input stage.

As a result of the determination in the operation S24, if the third signal does not return within the marginal reference range, the apparatus to sense and control the malfunction in the BOP generates a system alarm to report the malfunction in the fuel supplier and outputs the system alarm generated to an alarm apparatus (S26). The alarm apparatus includes a device manufactured by utilizing any one of or combination of light, sound, and vibration so that a user or a manager can recognize the system alarm, for example, a display, a speaker, a lamp, a light emitting diode (LED), a computer terminal connected via a wired or a wireless communication, a portable apparatus, and the like. Meanwhile, as a result of the determination in the S24, if the third signal returns within the marginal reference range, the process for sensing and controlling the malfunction in the BOP is terminated and restarted.

If the third signal is not within the marginal reference range as determined in operation S24, the apparatus to sense and control a malfunction in the BOP transfers a system alarm signal to the alarm apparatus and then initializes the apparatus to sense and control a malfunction in the BOP and terminates the process for sensing and controlling the malfunction in the BOP (S28). The operation S28 adjusts the apparatus in response to unexpected errors of the apparatus to sense and control the malfunction in the BOP due to environment, such as temperature, etc. The operation S28 can be implemented to be manually performed by a user or a manager recognizing the system alarm after lapse of a predetermined time or to be automatically performed.

FIG. 4 is a graph to illustrate results to which the method sensing and controlling a malfunction in BOP according to aspects of the present invention is applied. FIG. 4 shows a history of electric energy produced from a fuel cell stack, that is, an accumulated output power. The experiment used a fuel cell system including a fuel pump having a maximum output capacity of 5 cc/min, a direct methanol fuel cell stack with an output of 32 kW/h, and an air pump to supply power to loads having power consumption of 25 mWh. The stack accumulated output power in mWh generated was recorded. And, the experiment used the fuel pump about 1,000 times so as to cause a malfunction in the fuel pump.

The dotted line in the FIG. 4 is an expected graph for an ideal accumulated output power measured in the stack and the solid line is a graph for an accumulated output power actually measured in the stack. As shown in FIG. 4, intervals indicated by A, B, C, D and E are present in the accumulated output power actually measured in the stack, wherein the intervals indicate portions where the output power of the stack is not accumulated. The intervals of the A, B, C, D and E can be determined that the fuel pump is malfunctioned such that fuel to the fuel cell stack is limited as the fuel cell stack is operating in a state in which there is little output therefrom.

The apparatus to sense and control the malfunction in the BOP according to aspects of the present invention senses at least one of the driving voltage, the driving current, and the driving waveform of the fuel pump and then compares the sensed signal with a reference to determine whether the sensed signal is in a reference range as well as compares the accumulated output power with the expected output power to more accurately detect a malfunction in the fuel pump.

Further, in the case that aspects of the present invention are applied to a direct methanol fuel cell system including a fuel circulating apparatus for reusing unreacted fuel and/or water from the fuel cell stack as the fuel, aspects of the present invention may further comprise calculating the amount of fuel not being supplied to the fuel circulating apparatus in response to the intervals A, B, C, D, and E of the accumulated output power measured in the stack and supplying the calculated amount of fuel so that it can maintain the concentration of fuel supplied to the fuel cell stack at a desired concentration, i.e., an optimal concentration of fuel. Accordingly, aspects of the present invention can prevent an adverse effect on a continuous operation of the fuel cell system due to the variation of the concentration of fuel.

In addition, according to aspects of the present invention, the method and apparatus can detect a malfunction in the fuel pump, and if the detected malfunction frequency is above a predetermined frequency, implement compensation for the error caused by the malfunction in the fuel pump based on a predefined concentration of fuel corresponding to the concentration of fuel obtained by a concentration sensor or the output voltage, the output current, and the temperature of the fuel cell stack

According to aspects of the present invention, the method and apparatus can prevent an adverse effect to the fuel cell system by a malfunction in the balance of plant for the fuel cell so that the fuel cell system can continuously be operated by securing the stability and the reliability thereof.

The apparatus to sense and control the malfunction in the balance of plant according to aspects of the present invention is implemented by a microprocessor. Further, any digital signal processor having a function similar to that of the microprocessor can be applied in aspects of the present invention.

As described above, aspects of the present invention can improve stability and reliability of a fuel cell system and prevent an adverse effect on a continuous operation of the fuel cell system by detecting a malfunction in the balance of plant for the fuel cell, compensating for the errors caused by the malfunction and/or initializing the malfunctioning balance of plant or the control apparatus itself. For example, when the concentration of fuel supplied to the fuel cell stack by the malfunction in the fuel pump is changed, aspects of the present invention compensate to maintain the concentration of fuel at a suitable level for the fuel cell system, thereby improving efficiency, stability, and reliability of the fuel cell system.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An apparatus sensing and controlling a malfunction in a balance of plant for a fuel cell, the apparatus being coupled with a fuel cell system including a fuel cell stack to generate electric energy by electrochemically reacting a fuel with an oxidizer and the balance of plant to supply the fuel and the oxidizer, the apparatus comprising:
a microprocessor comprising:
an arithmetic logic unit (ALU) to perform calculations;
a register to temporally store data and instructions;
a controller to control the operation of the fuel cell system;
a first input stage to receive a first detecting signal to operate the fuel cell system;
an output stage to apply a control signal generated by the controller to the balance of plant; and
a second input stage to receive a second detecting signal to detect the malfunction in the balance of plant.

2. The apparatus as claimed in claim 1, wherein the second detecting signal comprises a signal transferred from a sensor that detects at least one selected from a group consisting of a driving voltage, a driving current, and a driving waveform, the sensor being coupled with the balance of plant.

3. The apparatus as claimed in claim 1, wherein the microprocessor initializes the second input stage if the second detecting signal is beyond a reference range.

4. The apparatus as claimed in claim 3, wherein the microprocessor generates a control signal to compensate for errors caused by a malfunctioning apparatus of the balance of plant and supplies the generated control signal to the malfunctioning apparatus if the second detecting signal returns to the reference range.

5. The apparatus as claimed in claim 4, wherein the generated control signal accelerates a fuel supplier for a predetermined time to compensate for a shortage of fuel if the malfunction was in the fuel supplier.

6. The apparatus as claimed in claim 3, wherein, after the second input stage is initialized, the microprocessor initializes a malfunctioning apparatus of the balance of plant if the second detecting signal is beyond a marginal reference range.

7. The apparatus as claimed in claim 6, wherein, after the malfunctioning apparatus is initialized, if the second detecting signal remains beyond the marginal reference range, the microprocessor generates an alarm signal to indicate the malfunction of the balance of plant and outputs the generated alarm signal to an alarm apparatus.

8. The apparatus as claimed in claim 7, wherein the alarm apparatus indicates receipt of the generated alarm signal through at least one of light, sound, and vibration so that the alarm signal is recognizable.

9. The apparatus as claimed in claim 7, wherein after the alarm signal is output, the microprocessor initializes.

10. The apparatus as claimed in claim 1, wherein the microprocessor initializes a malfunctioning apparatus of the balance of plant if the second detecting signal is beyond a marginal reference range.

11. The apparatus as claimed in claim 10, wherein after the malfunctioning apparatus of the balance of plant is initialized, if the second detecting signal remains beyond the marginal reference range, the microprocessor generates an alarm signal to indicate the malfunction in the balance of plant and outputs the generated alarm signal to an alarm apparatus.

12. The apparatus as claimed in claim 11, wherein the alarm apparatus indicates receipt of the generated system alarm signal through at least one of light, sound, and vibration so that the system alarm signal is recognizable.

13. The apparatus as claimed in claim 11, wherein, after the microprocessor outputs the alarm signal, the microprocessor initializes.

14. The apparatus as claimed in claim 1, wherein the balance of plant comprises:
a low power driver to control at least one selected from a group consisting of a fuel pump, an air pump, a blower, a pan, and a valve,
wherein the control signal is applied to the low power driver.

15. A method for sensing and controlling a malfunction in a balance of plant for a fuel cell with an apparatus to sense and control, which is coupled with a fuel cell system including a fuel cell stack generating electric energy and the balance of plant having a fuel supplier for supplying the fuel, the method comprising:
receiving signals transferred from a sensor, which is coupled with the fuel supplier and detects, at time intervals, the received signals being at least one selected from a group consisting of a driving voltage, a driving current, and a driving waveform;
determining whether a received first signal is beyond a reference range;
initializing an input stage that received the received first signal;
determining whether a received second signal is beyond the reference range; and
compensating for errors caused by the malfunction in the fuel supplier if the received second signal is not beyond the reference range.

16. The method as claimed in claim 15, further comprising:
initializing the fuel supplier if the second signal is beyond the reference range and is beyond a marginal reference range.

17. The method as claimed in claim 16, further comprising:
generating an alarm signal to indicate the malfunction of the fuel supplier and outputting the alarm signal to an alarm apparatus if a received third signal remains beyond the marginal reference range after initializing the fuel supplier.

18. The method as claimed in claim 17, further comprising:
initializing the apparatus to sense and control if the received third signal remains beyond the marginal reference range.

19. The method as claimed in claim 16, further comprising:
initializing the apparatus to sense and control if the received third signal remains beyond the reference range after initializing the fuel supplier.

20. The method as claimed in claim 15, wherein the apparatus to sense and control comprises:
a microprocessor comprising:
an arithmetic logic unit (ALU) to perform calculations;
a register to temporally store data and instructions;
a controller to control the operation of the fuel cell system,
a first input stage input with state variable information to operate the fuel cell system;
an output stage to apply a control signal generated by the controller to the balance of plant; and
a second input stage to receive the signals transferred from the sensor.

21. A method for sensing and controlling a malfunction in a balance of plant of a fuel cell system, the method comprising:
determining whether a first received signal from an apparatus of the balance of plant is within a reference range;
initializing an input stage that received the first received signal if the first received signal is not within the reference range;
determining whether a second received signal from the apparatus of the balance of plant is within the reference range;
initializing the apparatus of the balance of plant if the second received signal is not within the reference range;
determining whether a third received signal of the apparatus of the balance of plant is within a marginal reference range; and
generating an alarm signal and outputting the alarm signal to an alarm apparatus if the third received signal of the apparatus of the balance of plant is not within the marginal reference range.

22. The method of claim 21, further comprising:
initializing an apparatus to sense and control the malfunction in the balance of plant of the fuel cell system if the third received signal of the apparatus of the balance of plant is not within the marginal reference range.

23. The method of claim 21, further comprising:
generating the alarm signal and outputting the alarm signal to the alarm apparatus if the second received signal of the apparatus of the balance of plant is not within the reference range.

24. The method of claim 21, further comprising:
compensating for the malfunction of the apparatus of the balance of plant if the second received signal is within the reference range.

25. The method of claim 24, wherein the compensating comprises:
increasing an amount of fuel supplied to a fuel cell or increasing a concentration of the fuel if the malfunction of the apparatus of the balance of plant is in a fuel supplier.
